(19) United States
(12) Patent Application Publication
(10) Pub. No.: US 2015/0180735 A1
(43) Pub. Date: Jun. 25, 2015

(54) APPARATUS AND METHOD FOR PROVIDING COLLABORATIVE SERVICE BASED ON VIRTUAL RESOURCES

(71) Applicant: KOREA ELECTRONICS TECHNOLOGY INSTITUTE, Seongnam-si (KR)

(72) Inventors: Jong Bin PARK, Hwaseong-si (KR); Jong Jin JUNG, Seoul (KR); Tae Beom LIM, Yongin-si (KR); Kyung Won KIM, Seoul (KR); Seung Woo KUM, Yongin-si (KR); Jae Won MOON, Seoul (KR)

(73) Assignee: KOREA ELECTRONICS TECHNOLOGY INSTITUTE, Seongnam-si (KR)

(21) Appl. No.: 14/264,778

(22) Filed: Apr. 29, 2014

(30) Foreign Application Priority Data
Dec. 24, 2013 (KR) 10-2013-0162215

(51) Int. Cl. H04L 12/24

(52) U.S. Cl. CPC H04L 41/5054; H04L 41/22

(57) ABSTRACT

Provided is a method for providing a collaborative service based on virtual resources including generating virtual resources virtualized according to unique services or characteristics of devices connected through an assist gateway in a specific space and collecting virtual resource information including internal states of the virtual resources and services provided by the virtual resources, configuring a collaborative service with respect to the virtual resources using the virtual resource information, and generating a control command with respect to at least one or more virtual resources defined in a requested collaborative service.

### CROSS-REFERENCE TO RELATED APPLICATIONS

This application claims priority under 35 U.S.C. §119 to Korean Patent Application No. 10-2013-0162215, filed on Dec. 24, 2013, the disclosure of which is incorporated herein by reference in its entirety.

### TECHNICAL FIELD

The present invention relates to a method and apparatus for providing a collaborative service based on virtual resources, and more particularly, to a technique of providing new functions and services by various devices in a collaborative manner in an area such as houses, offices, and the like.

### BACKGROUND

There are multiple IT information devices in spaces such as houses or offices to provide specified functions. Also, heterogeneous devices have evolved to share information and interwork via a network. However, in order for devices to provide new functions, additional components and functions need to be added, and here, such additional functions are used for limited purposes to achieve purposes thereof.

Functions provided by several devices may frequently overlap with each other. In a case in which a specific device provides a function and a different device has the same function, the same function of the different device may not be used in actuality, which may be waste in the user side.

For example, specific devices may have a screen display device, and in this case, each device may use a corresponding screen display device alone. Conversely, a device without a screen display device may be connected to a screen display device such as a monitor through a physical connection line to display a screen. Also, a device may not include an output device so it may not be able to provide a user interface for a screen.

In a related art, for example, legacy devices not supporting a communication function may not be automatically controlled to interwork with other IT information devices. In addition, additional installation of a network communication module or a screen display device in newly released devices may increase costs, burdening manufacturers or consumers.

Existing patents (Registration No. 10-1024407, 10-0570532, etc.) propose methods for remotely controlling in-house devices. However, these methods do not provide a solution with respect to a method of controlling legacy devices nor provide a function of providing a new service with virtual resource by classifying the devices by functions and roles.

### SUMMARY

Accordingly, the present invention provides a method for providing a new service by devices connected via a network in collaboration with each other.

The present invention also provides a method and apparatus for providing a collaborative service based on virtual resources capable of automatically collecting information of devices connected via a network, defining the devices as abstracted virtual resources, processing the defined virtual resources using calculation resource of the same space or a remote area, and subsequently distributing the same to virtual resources connected to the network to provide a new service.

The object of the present invention is not limited to the aforesaid, but other objects not described herein will be clearly understood by those skilled in the art from descriptions below.

In one general aspect, a method for providing a collaborative service based on virtual resources includes: generating virtual resources virtualized according to unique services or characteristics of devices connected through an assist gateway in a specific space and collecting virtual resource information including internal states of the virtual resources and services provided by the virtual resources; configuring a collaborative service with respect to the virtual resources using the virtual resource information; and generating a control command with respect to at least one or more virtual resources defined in a requested collaborative service.

In another general aspect, an apparatus for providing a collaborative service based on virtual resources includes: a virtual resource generating unit configured to generate virtual resources virtualized according to unique services or characteristics of devices connected through an assist gateway in a specific space and collecting virtual resource information including internal states of the virtual resources and services provided by the virtual resources; a collaborative service configuring unit configured to configure a collaborative service with respect to the virtual resources using the virtual resource information; and a virtual resource controller configured to generate a control command with respect to at least one or more virtual resources defined in a requested collaborative service.

Other features and aspects will be apparent from the following detailed description, the drawings, and the claims.

In the related art, sensors, components, or the like, of devices are used only for intrinsic purposes thereof, and a control element independently controls the sensors, components, or the like. In contrast, according to the present invention, devices share state information and a control service through intercommunication, whereby new virtual resource may be created through collaboration between existing devices to advantageously provide functions and services.

In the related art, in order for devices used in spaces such as houses or offices to interwork with a network to additionally perform a specific function, separate hardware components or software functions need to be added during a product manufacturing process. However, in the present invention, devices may be managed through virtual resources, while reducing the burden of cost, to provide various and new additional functions.

In the related art, legacy devices not supporting a communication function are not automatically controlled and thus cannot interwork with other IT information devices. Besides, installation of a network communication module or a screen display device in newly manufactured devices may not easily be attempted because it significantly increases costs. In the present invention, in order to solve such problems, a lightweight control module (e.g., a light micro-controller) and an assist gateway are provided to allow legacy devices to be collaboratively controlled with up-to-date IT information devices, whereby existing legacy devices, sensor modules, actuators, and the like, may be registered as new virtual resources through interworking with the lightweight control module and the assist gateway. Accordingly, information or additional functions obtained from legacy devices may be used by other devices, or a new service may be provided to other devices.

### BRIEF DESCRIPTION OF THE DRAWINGS

FIG. 1 is a view illustrating an overall framework of a system for providing a collaborative service based on virtual resources according to an embodiment of the present invention.

FIG. 2 is a block diagram illustrating an example of a specific configuration of an assist gateway and a virtual resource processing unit illustrated in FIG. 1.

FIG. 3 is a block diagram illustrating an example of connection relationships between the assist gateway, a lightweight control module, and home appliances.

FIG. 4 is a block diagram illustrating an example of a method for registering resources through the lightweight control module connected to the assist gateway.

FIG. 5 is a block diagram illustrating another example of a specific configuration of the assist gateway and the virtual resource processing unit illustrated in FIG. 1.

FIG. 6 is a flow chart illustrating a method for extracting an interested object according to an embodiment of the present invention.

FIG. 7 is a view illustrating a control method using gestures of virtual resources using a situation information processing unit according to an embodiment of the present invention.

FIG. 8 is a view illustrating a method for tracking an object location in a space using the situation information processing unit according to an embodiment of the present invention.

FIG. 9 is a view illustrating another method for tracking an object location in a space using the situation information processing unit according to an embodiment of the present invention.

FIG. 10 is a view illustrating another method for tracking an object location in a space using the situation information processing unit according to an embodiment of the present invention.

FIG. 11 is a view illustrating a first utilization example of a wide-angle projector.

FIG. 12 is a view illustrating a second utilization example of a wide-angle projector.

### DETAILED DESCRIPTION OF EMBODIMENTS

Hereinafter, embodiments of the present invention will be described in detail with reference to the accompanying drawings.

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

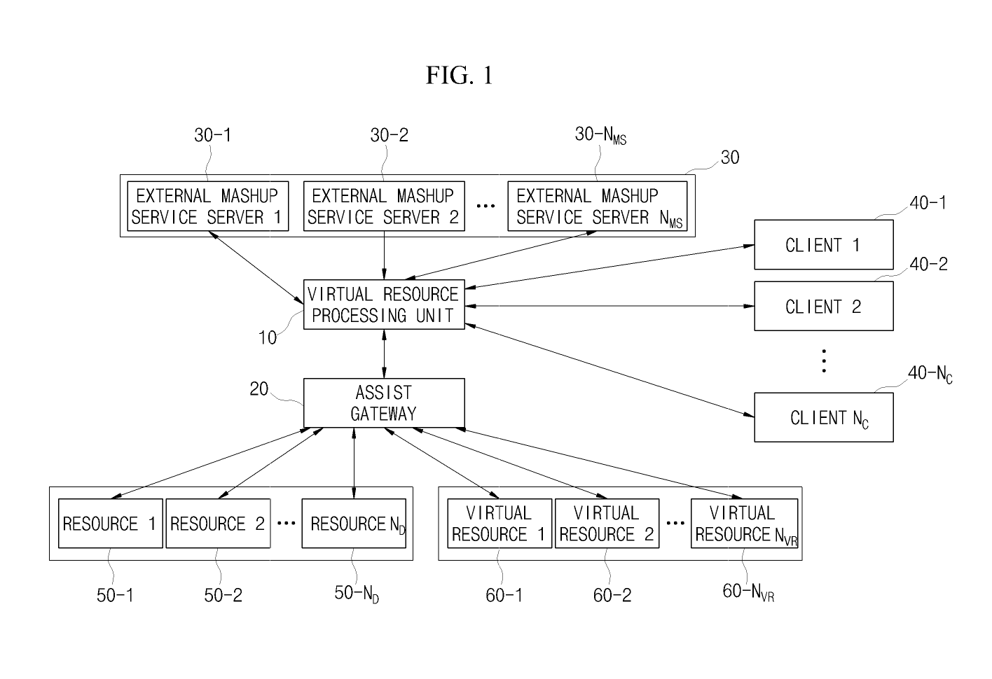

FIG. 1 is a view illustrating an overall framework of a system for providing a collaborative service based on virtual resources according to an embodiment of the present invention.

Referring to FIG. 1, the system for providing a collaborative service based on virtual resources according to an embodiment of the present invention includes a virtual resource processing unit 10, an assist gateway 20, an external mashup service server 30, a client terminal 40, actual resources such as electronic devices, and virtual resources 60 obtained by abstracting electronic devices, and the like.

Here, virtual resources may be defined as devices virtualized according to services or characteristics inherent to devices. For example, if a single physical device has one or more services or unique characteristics, it may be considered as including several virtual resources. Conversely, a single virtual resource may separately exist in several places physically. For example, an electric light, a TV, an audio device, and a printer may each be an independently virtual resource, but may be grouped into units {electric light+audio device}, {electric light+audio device+printer}, and the like, to collaboratively support services.

Information items of various resources existing in a space such as a house or an office are collected through the assist gateway 20. The assist gateway 20 may interwork with the virtual resource processing unit 10 to generate several virtual resources to provide new functions and services. Each of the virtual resources may configure a collaborative service through the virtual resource processing unit 10 or the external mashup service servers 30 separated from the virtual resource processing unit 10 to transmit commands related to the collaborative service to the assist gateway 20.

The virtual resource processing unit 10 controls the resources 50 or the virtual resources 60 connected to the assist gateway 20 to provide a collaborative control service. In this case, the virtual resource processing unit 10 may provide a user interface displaying state information, a control method, or the like, to the client 40 who has accessed using a different computer, a mobile device, or the like, to allow for controlling even in a remote area.

The user interface generated by the virtual resource processing unit 10 may also be used by the virtual resources 60 connected to the assist gateway 20. For example, a user interface for monitoring and controlling situation information is also provided to resources without a screen display device, through collaborative controlling.

Also, in the embodiment of the present invention, a function of monitoring a space and obtaining situation information of the corresponding space is provided. For example, a situation in a space such as a house, an office, or the like, is automatically recognized and used in a collaborative service.

Meanwhile, constants described in FIG. 1 have meanings as follows, which mean that a plurality of resources or services, not one, may interwork.

N_{MS}: Number of external mashup service servers connected to the virtual resource processing unit

N_{D}: Number of devices connected to the assist gateway

N_{C}: Number of clients connected to the virtual resource processing unit

N_{VR}: Number of virtual resources connected to the assist gateway

Meanwhile, although not shown in FIG. 1, a single virtual resource processing unit may manage a plurality of assist gateways. For example, a virtual resource processing unit and an assist gateway may be adjacently located together in a space, or in another example, assist gateways may be separately exist in individual spaces and a single virtual resource processing unit located in a remote area may collectively manage the assist gateways.

The external mashup service servers 30 serve to create various collaborative services such as security, medical care, health care, and the like, based on an application programming interface (API) provided from the virtual resource processing unit 10, and provide the same to service subscribers. Namely, collaborative services not configured by the virtual resource processing unit 10 may be configured by the external mashup service servers 30 through an API provided from the virtual resource processing unit 10.

The client 40 refers to various mobile devices such as a personal computer (PC), a smartphone, and a tablet device existing in a remote area. For example, the client 40 may be a device including a browser capable of processing Web information in format such as HTML or HTML5 to maintain compatibility between various connection platforms.

The client 40, a device expressing monitoring information and control information processed by a user interface generating unit 15 and performing a command, selectively receives service information only for an authenticated user.

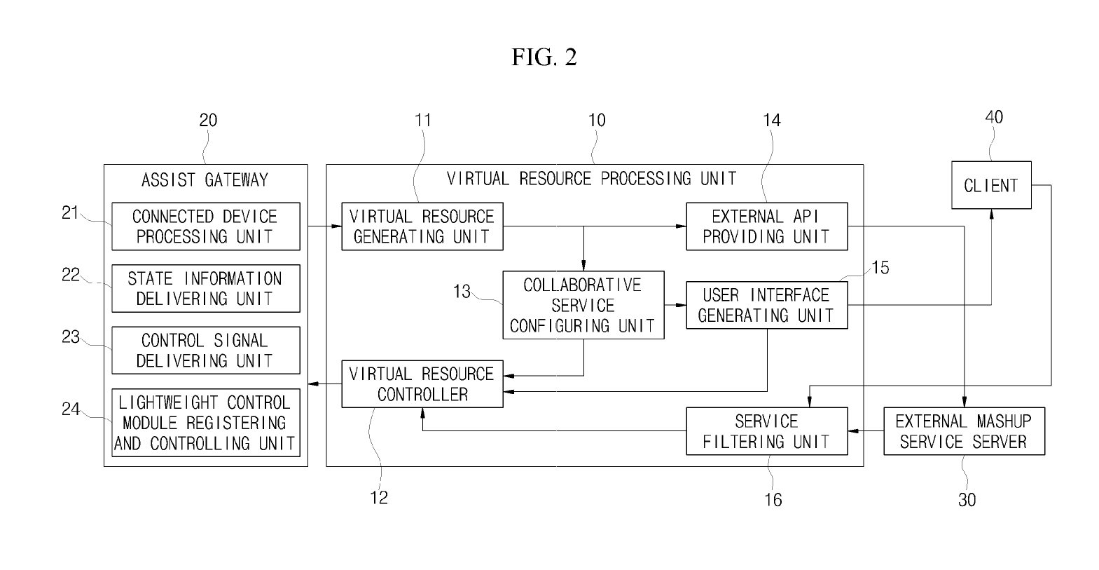

FIG. 2 is a block diagram illustrating an example of a specific configuration of the assist gateway and the virtual resource processing unit illustrated in FIG. 1.

Hereinafter, a configuration of the assist gateway and the virtual resource processing unit according to an embodiment of the present invention will be described in detail with reference to FIG. 2.

The assist gateway 20 includes a connection device processing unit 21, a state information delivering unit 22, a control signal delivering unit 23, and a lightweight control module registering and controlling unit 24.

The assist gateway 20 may first recognize connected devices using network technologies, recognize the corresponding devices as resources, and subsequently collect state information regarding recognized resources.

For example, the assist gateway 20 recognizes virtual resources existing in a specific space and collects internal states, provided service information, and the like, of the current virtual resources. Also, the assist gateway 20 provides functions of delivering the recognized information to a different device within a network or a difference device connected to an external network.

To this end, the assist gateway 20 and virtual resources are connected via a network using agreed communication protocols. For example, universal plug and play (UPnP) is one of communication protocols.

UPnP refers to an aggregation of communication protocols allowing content or services provided by virtual resources to be easily shared and controlled. Virtual resources supporting UPnP may be easily recognized by other devices within a network, share content, and control devices or be controlled by devices. The foregoing UPnP protocol is described as an example supporting a network connection between virtual resources, and the present invention is not limited thereto. For example, a method of synchronously or asynchronously collecting state information by using a network architecture such as representational state transfer (REST), an inter-device communication method using message passing interface (MPI), ZigBee, Bluetooth, or the like, a method of registering virtual resource information directly by a user, or the like, may be used. However, most preferably, virtual resources connected to a network are automatically recognized by minimizing conscious information registering process and state information of respective virtual resources is continuously collected and managed.

Meanwhile, the assist gateway 20 recognizes which of services may be provided by using various home network middleware technologies such as UPnP, HAVi, Jini, OSGi, and the like. In detail, the connection device processing unit 21 recognizes devices connected to the assist gateway 20 as resources, and the state information delivering unit 22 transmits state information regarding the respective resources to the virtual resource processing unit 10. The control signal delivering unit 23 serves to deliver a control command transmitted from the virtual resource processing unit 10 to respective resources. The lightweight control module registering and controlling unit 24 registers legacy home appliances or devices without home network middleware, as resources and supports a collaborative service.

Although not shown in FIG. 2, in the present invention, a lightweight module refers to a module which is low in price, allows various types of sensors to be easily attached, like a microcontroller including a digital input/output, an analog/digital converter, and the like, and is easily connected to an existing legacy home appliance.

For example, legacy devices, such as an electric fan, a humidifier, a lamp, and the like, not supporting a communication function, may not be available to be automatically controlled, so these devices may not interwork with other IT information devices. Also, even in case of newly manufactured devices, installation of a network communication module or a screen display device increases costs too significantly to be attempted. A method of using the assist gateway and the lightweight control module to enable legacy devices to be collaboratively controlled with up-to-date IT information devices, while addressing these problems, is employed.

In detail, when the lightweight control module is connected to the assist gateway 20 through ZigBee, Ethernet, USB, serial communication, Bluetooth, and the like, the virtual resource processing unit 10 may register legacy devices, a sensor module, an actuator, and the like, connected to the lightweight control module, as new virtual resources. Accordingly, information and additional functions obtained from the legacy devices may also share information and services with other devices.

The lightweight control module may have limited calculation performance, compared to calculation resources such as a PC in consideration of cost, battery consumption, or the like. Namely, it is difficult to install a complicated middleware protocol. Thus, preferably, the lightweight control module is connected to the assist gateway by using simple communication protocols as possible in terms of software in case of using a physical connection such as Ethernet, Bluetooth, ZigBee, USB connection, serial communication, and the like, and a complicated operation such as interworking with an external network, or the like, is dealt with by the assist gateway.

However, it may be difficult for the assist gateway to secure information regarding which functions the lightweight control module provides, and in order to solve this problem, when the lightweight control module is connected, the assist gateway performs a process of registering what kind of resource the lightweight control module is or which services the lightweight control module provides.

In this manner, the virtual resource processing unit 10 may continuously obtain state information of legacy devices connected via a network through the lightweight control module, and deliver control information to the legacy devices. For example, the lightweight control module and the assist gateway 20 may communicate by using a simple transmission protocol such as JSON.

In an embodiment of the present invention, functions of the lightweight control module and the assist gateway 20 may be separated in consideration of their advantages. The lightweight control module may be easily connected to various sensors and devices but operate with relatively low complexity. In contrast, the assist gateway 20 may have a communication function and relatively high calculation capabilities.

The assist gateway 20 may provide a function of a middleware protocol such as UPnP to lightweight control modules connected thereto in a wired manner or wirelessly to allow devices connected to the lightweight control modules to operate with the middleware protocol such as UPnP in the same manner as that of existing smart devices in a space such as a house or an office. Namely, several lightweight control modules, lacking the ability to perform communication or calculation, may process such communication connection function or complicated calculations by means of the assist gateway 20.

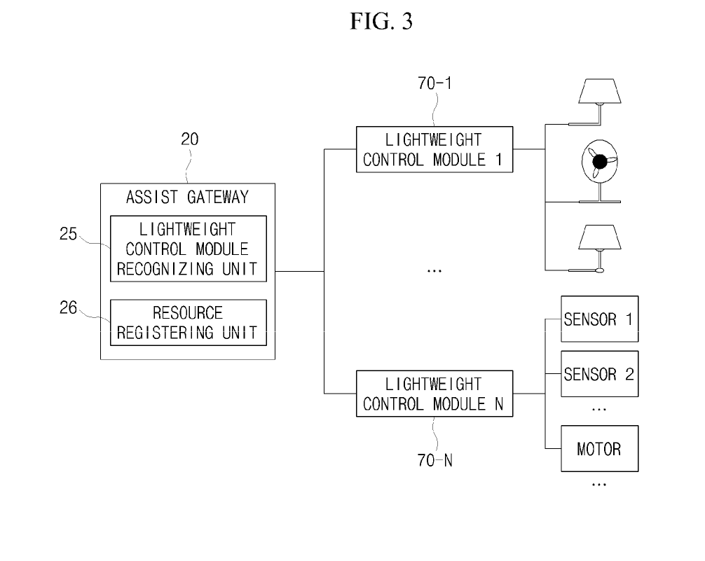

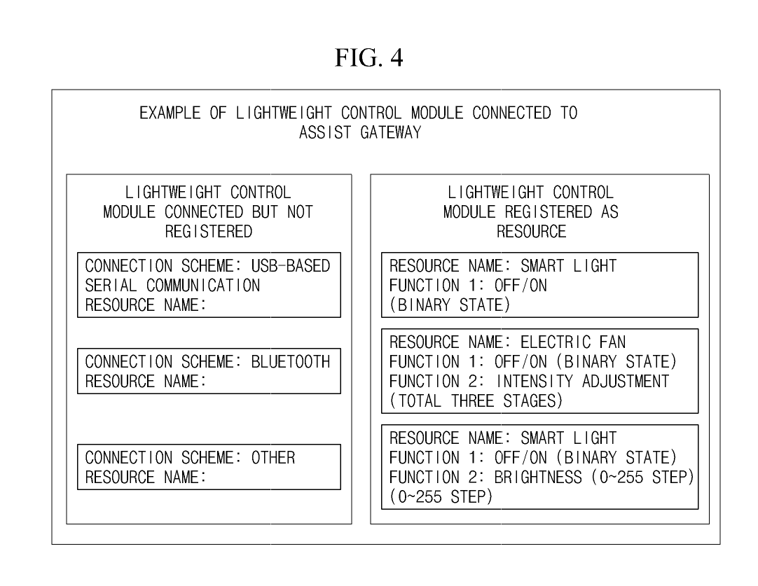

FIGS. 3 and 4 illustrate an example of connection relationship among the assist gateway, the lightweight control modules, and home appliances and a method for registering resources through the lightweight control modules connected to the assist gateway.

For example, it is assumed that N number of lightweight control modules 70 is connected to the assist gateway 20 and several devices are connected to each of the lightweight control modules 70. In FIG. 3, a lightweight control module 1 70-1 is connected to two electric lights and an electric fan.

Referring to FIG. 4, there may be lightweight control modules which have been connected to the assist gateway 20 but not registered as resources on one hand, and there may be lightweight control modules which have been registered as resources on the other hand. For example, in a case in which lightweight control modules are connected to the assist gateway but not registered as resources, a user interface is provided to allow a user to define names of the resources and add functions provided by the respective resources.

Referring back to FIG. 2, the virtual resource processing unit 10 according to the embodiment of the present disclosure will be described in detail.

The virtual resource processing unit 10 includes a virtual resource generating unit 11, a collaborative service configuring unit 13, an external API providing unit 14, a user interface generating unit 15, a virtual resource controller 12, and a service filtering unit 16.

The virtual resource processing unit 10 may manage one or a plurality of assist gateways, and grant authority to monitor and control a state of a corresponding assist gateway to authenticated clients 40 and provide a relevant user interface.

Also, the virtual resource processing unit 10 provides an API for controlling virtual resources to the external mashup service servers 30. The virtual resource processing unit 10 may configure a new collaborative service through the API to control virtual resources.

Meanwhile, the service filtering unit 16 may serve to interrupt a malicious virtual resource control command, and the like, that may cause a problem of security.

The virtual resource generating unit 11 generates virtual resources based on device information collected through the assist gateway 20. To this end, the virtual resource generating unit 11 collects information regarding which services each device provides. In other words, the virtual resource generating unit 11 may perform a process of registering services provided by respective devices.

For example, it is assumed that four controllable electric lights providing different functions are provided (but not limited thereto). In this example, electric light D₁ provides five services including S₁: ON, S₂: OFF, S₃: gradually brightened to be turned on, S₄: gradually darkened to be turned off, S₅: flickering, and an electric light D₃ provides three services including S₁: ON, S₂: OFF, and S₃: color adjustment (Y, Cb, Cr).

TABLE 1

| | | Service | | | | | |
|---|---|---|---|---|---|---|---|
| | | S1 | S2 | S3 | S4 | S5 | . . . |
| De- | D1 | ON | OFF | Gradually | Gradually | Flick- | . . . |
| vice | | | | brightened to be | darkened to be | ering | |
| | | | | turned on | turned off | | |
| | D2 | ON | OFF | Color adjustment | N/A | | . . . |
| | | | | (R, G, B) | | | |
| | D3 | ON | OFF | Color adjustment | N/A | | . . . |
| | | | | (Y, Cb, Cr) | | | |
| | D4 | ON | OFF | Sleep mode | N/A | | . . . |
| | . . . | . . . | . . . | . . . | . . . | . . . | . . . |

The virtual resource generating unit 11 generates respective devices as virtual resources, and examples of services of respective devices are illustrated in Table 2. For example, in Table 2, virtual resource R₁ may use five services (S₁, S₂, S₃, S₄, S₅) provided by device D₁ and use all the service functions provided by respective devices D₂, D₃, and D₄.

Meanwhile, virtual resource R₄ may use only services D₃ (S₁, S₂, S₃) and D₄ (S₁, S₂, S₃) but not the services provided by D₁ and D₂. Through such a resource reconfiguration, the virtual resource generating unit 11 may set a security level with respect to controlling (for example, the virtual resource generating unit 11 grant authority to use virtual resources providing many functions to a user and a service having high control authority and grants authority to use limited virtual resource to a user and a service having relatively low control authority) and provide various types of collaborative service.

TABLE 2

| | | Generated virtual resource |
|---|---|---|
| Virtual | R₁ | D₁ (S₁, S₂, S₃, S₄, S₅), D₂ (S₁, S₂, S₃), D₃ (S₁, S₂, S₃), |
| resource | | D₄ (S₁, S₂, S₃) |
| | R₂ | D₁ (S₁, S₂), D₂ (S₁, S₂), D₃, (S₁, S₂), D₄ (S₁, S₂), |
| | R₃ | D₁ (S₁, S₂, S₃, S₄, S₅), D₂ (S₁, S₂, S₃) |
| | R₄ | D₃ (S₁, S₂, S₃), D₄ (S₁, S₂, S₃) |

Generation of new collaborative services using the virtual resources generated as shown in Table 1 and Table 2 is shown in Table 3. In Table 3, rows indicate virtual generated resources, and columns indicate provided services. For example, a collaborative service S₁ of “All ON” for turning on all the electric lights is mapped to S₁ cell of virtual resource R₁. In order to actually implement “All ON” of the S₁ cell of virtual resource R₁, D₁ may be turned on, D₂ may be turned on, D₃ may be turned on, and D₄ may be subsequently turned on. The sequential procedure may be represented as (D₁:S₁, D₂:S₁, D₃:S₁, D₄:S₁), in which the notation D:Sₐ, S_{b}, S_{c} denotes performing services of Sₐ, S_{b}, S_{c} for device D.

TABLE 3

| | | Collaborative service | | | |
|---|---|---|---|---|---|
| | | S₁ | S₂ | S₃ | . . . |
| Virtual resource | R₁ | All ON | All OFF | Mood mode | . . . |
| | R₂ | All ON | All OFF | N/A | . . . |
| | R₃ | D₁ and D₂ | D₁ and D₂ | N/A | . . . |
| | | ON | OFF | | |
| | R₄ | D₃ and D₄ | D₃ and D₄ | N/A | . . . |
| | | ON | OFF | | |
| | . . . | . . . | . . . | . . . | . . . |

Configuration of the collaborative service as mentioned above is performed by the collaborative service configuring unit 13.

A role of the collaborative service configuring unit 13 is not limited to simply grouping services and sequentially executing the services. For example, the collaborative service configuring unit 13 may create a collaborative service of controlling devices by performing condition, repetition, and branching based on state information such as general programming rules. In a specific example, the collaborative service configuring unit 13 may predefine a service operating during a particular time slot, a service operating when a particular event occurs in a connected device, and the like. Details of the collaborative service configuring unit 13 will be described hereinafter.

The user interface generating unit 15 generates a user interface with respect to state information monitored based on information of the virtual resources 60 connected to the assist gateway 20 and a control method. The user interface generated thusly may be used by a device to control other devices connected through the assist gateway 20.

Alternatively, a generated user interface may be provided to the client 40, and the client 40 monitors and controls virtual resources existing in a space such as a house or an office by using the user interface. Meanwhile, a user interface may be configured by using various methods and, preferably, it may be provided by using a Web-based interface such as HTML or HTML5 in terms of compatibility.

The external API providing unit 14 provides an API to the outside to allow various providers and developers to develop new services. For example, a REST architecture-based API allowing for easily processing information transmission in heterogeneous operating platform is preferred. In FIG. 2, the external API providing unit 14 is illustrated only to provide information from the virtual resource generating unit 11, but the external API providing unit 14 may provide a service processed by the collaborative service configuring unit 13 in the form of an API.

The external client 40 and the external mashup service server 30 determine an available API according to provided permission, and control virtual resources using the determined API. Meanwhile, errors due to various reasons or a malicious command may come from the external client 40 and the external mashup service server 30. Also, although the external client 40 and the external mashup service server 30 are granted authority (or permitted), a request for sensitive services associated with security and safety may be received therefrom. In the present invention, a service filtering unit 16 handles a function of checking such a situation in advance.

The service filtering unit 16 serves to interrupt problematic control commands in advance, or, if such control commands are executed, the service filtering unit 16 may give the alarm to a manager, or the like.

For interruption in advance, the service filtering unit 16 registers specific services to be interrupted to an interruption list in advance, or when an error or a problem occurs or arises while a specific service is in progress, the service filtering unit 16 adds the relevant services to the interruption list in real time such that the service commands may not be executed afterwards. Thus, when service information is introduced from the outside, the service filtering unit 16 compares it with services on the interruption list, and when the services are included in the interruption list, the service filtering unit 16 denies the services.

The virtual resource controller 12 converts configured collaborative service information and user interface information or service information delivered from the external mashup service server 30 through the service filtering unit 16 into commands so as to be executed by virtual resources, and delivers the converted commands to the assist gateway 20.

Also, the virtual resource controller 12 may provide a function of canceling an already delivered command. For example, the virtual resource controller 12 may provide a function such as Undo, Redo, or the like, that are frequently used in editing documents. To this end, previously executed command information is stored in a data structure such as a stack. The virtual resource controller 12 serves to undo an already executed command or redo a new command.

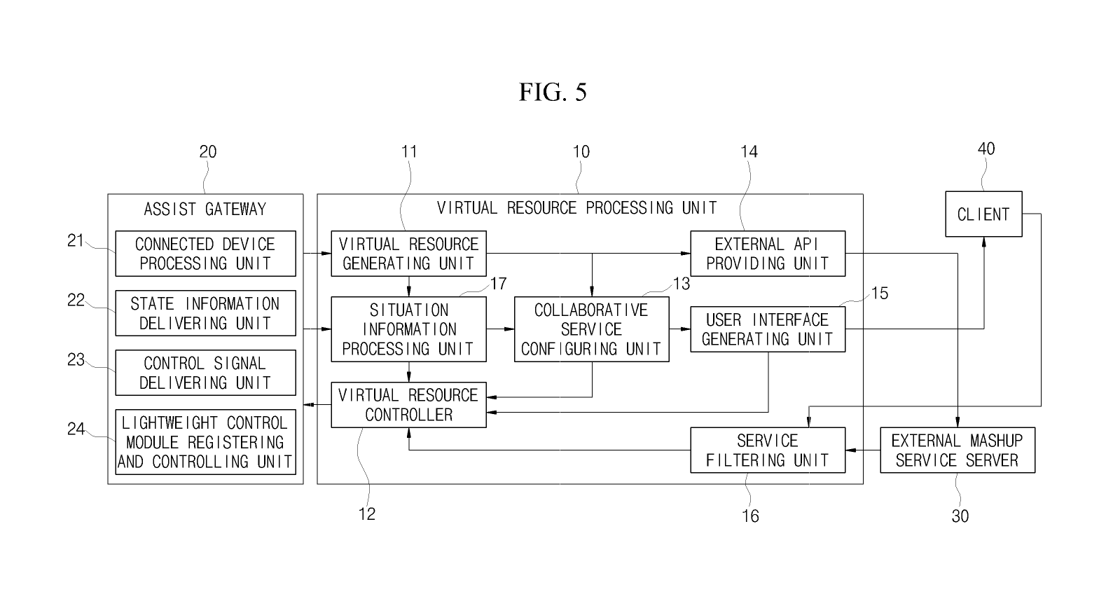

Meanwhile, in another embodiment of the present invention, the virtual resource processing unit 10 may further include a situation information processing unit 17. A configuration of the situation information processing unit 17 according to another embodiment of the present invention is illustrated in FIG. 5.

Situation information may be classified into four main categories such as a location of a device, a person, and the like, a unique identity, a unique activity, and time information. For example, devices connected to the assist gateway 20 may include a general two-dimensional (2D) video information obtaining camera, a stereoscopic camera, a multi-view camera including N number of cameras, a three-dimensional (3D) depth information obtaining camera, a human body sensor, and the like. By using these devices, monitoring information may be obtained in a space.

The situation information processing unit 17 extracts situation information in a space by analyzing the foregoing space monitoring information. In this manner, the situation information processing unit 17 may track and recognize persons or objects existing in a space, and calculate location information of the objects. In order to analyze situation information, techniques such as mechanical learning, pattern recognition, and the like, may be used.

Meanwhile, the analysis results of situation information may include an error. In consideration of this, in the present invention, analysis results may be divided into several levels depending on accuracy and difficulty of recognition regarding processed situation information. For example, accuracy of recognition may be divided into high, middle, and low levels to be provided, or difficulty of recognition may be divided into levels 1, 2, and 3 to provide analysis results. The situation information processing unit 17 may refer to the accuracy and difficulty of recognition in analyzing the situation information.

The situation information extracted by the situation information processing unit 17 may include, for example, location information of an object or a virtual resource in the space. Physical locations of objects may be continuously tracked and corresponding information may be accumulated to be used to configure a new collaborative service.

In detail, the situation information processing unit 17 performs tracking a location of an object to be searched. In the present invention, three types of object, i.e., a searched object, an interested object, and an associated object, are defined. The searched object is defined as an object to be searched in real time, the interested object is defined as a small number of objects whose information is continuously tracked, and the associated object is defined as a subset of objects associated with the searched object among interested objects.

The searched objects may vary, and detecting and tracking various types of objects each time requires a large amount of calculation. Meanwhile, various algorithms for detecting objects such as a user's face, hands, feet, and the like, have been developed, and a fast algorithm and even a hardware chip may be advantageously used. Thus, instead of directly searching for searched objects from space monitoring information such as images, interested objects associated with searched objects are continuously tracked to obtain location information thereof in advance, and when a request for a location of a searched object is received, the location information of interested objects is utilized.

Namely, in order to recognize object location information, a technique of calculating locations high probability of presence of objects, rather than calculating physical locations of objects, is used. Thus, a search space to be inspected by a user may be significantly reduced.

For example, accessories such as remote controllers, keys, or the like, are highly likely to be located in user's hands. Thus, if a searched object is a remote controller and a key, an associated object may be a user's hand. Preferably, regions having high correlation with certain other objects such as person's hands, feet, face, a face region, a movement region, and the like, are selected as interested objects. Also, objects whose location information is easily obtained, without causing an excessive amount of calculation, and having high accuracy of location recognition may be used as interested objects. Namely, in order to search for a searched object such as a remote controller or a key, a hand may be designated as an associated object among interested objects, and location information of the hand may be tracked to search for a location of a remote controller or a key.

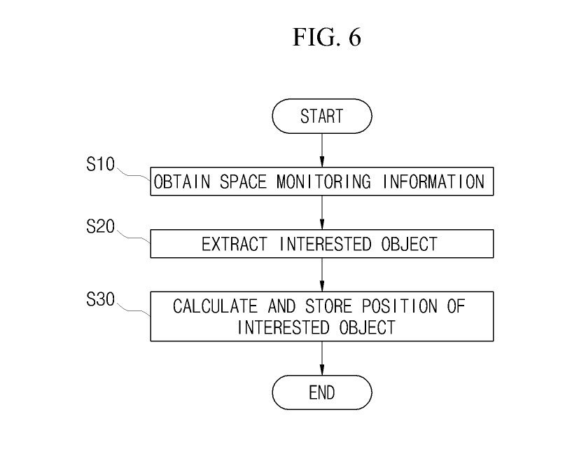

FIG. 6 is a flow chart illustrating a method for extracting an interested object according to an embodiment of the present invention.

Referring to FIG. 6, the situation information processing unit 17 obtains space monitoring information in step S10 to extract an interested object in step S20, and calculates and stores a location of the interested object in step S30. This process may be continuously performed by the situation information processing unit 17.

For example, it is assumed that a hand is designated as an interested object and location information of the hand is continuously obtained. Here, as a location of the hand, information regarding three dimensions such as (x,y,z) may be extracted or location information in image coordinates such as (x,y) may be extracted.

The space monitoring information is preferably image information, and even 3D depth information may be obtained as well by using an RGB-depth camera or a stereoscopic camera, a multi-view camera, or the like. When an obtained image is assumed as image information, an interested object is extracted from input image information. In order to track a location of a hand, a skin color may be used or a person may be first tracked by using prior knowledge attached to a body of the person and a location of a hand may be subsequently tracked. Also, a skeletal structure of a human body may be extracted by using depth information to track a location of a hand. Namely, various object tracking techniques may be used.

Meanwhile, in a case in which accessories such as a remote controller or a key are to be searched, the accessories are searched objects. A location of the accessories may be tracked by analyzing history of location information of a hand as an associated object of the accessories. In this case, prior knowledge may be additionally used. For example, the accessories are highly likely to be placed on a surface such as a floor. By additionally using such information, a location of accessories is tracked.

As another example of situation information, user identification information may be utilized. In order to identify a user, an ID, a password input method, biometric information such as a face, a fingerprint, an iris pattern, or a gait pattern may be used. According to the embodiment of the present invention, the foregoing methods may be selectively used for user identification. Also, a customized service may be provided by utilizing user identification information.

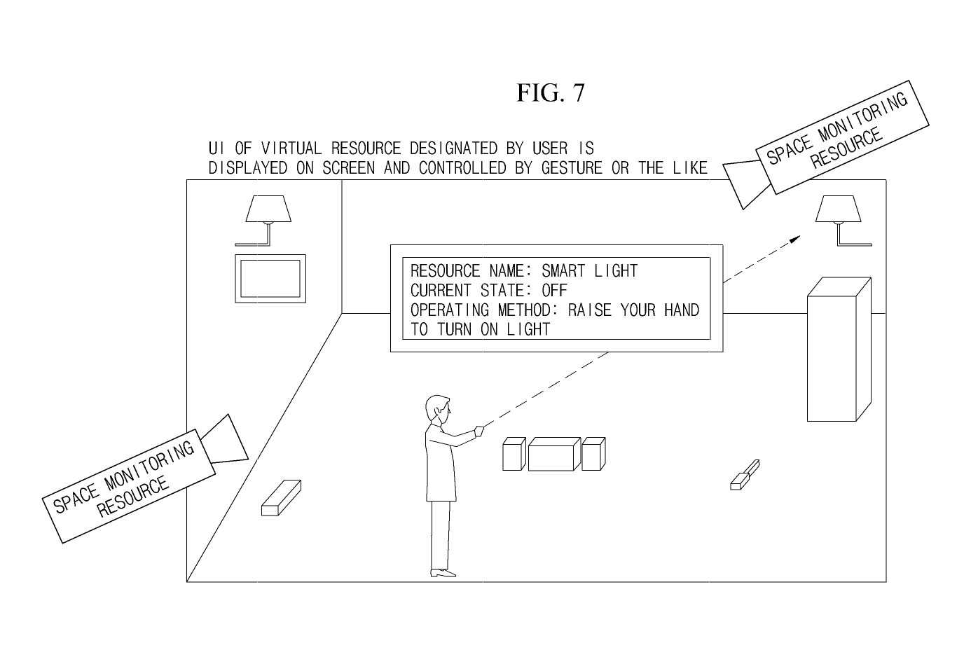

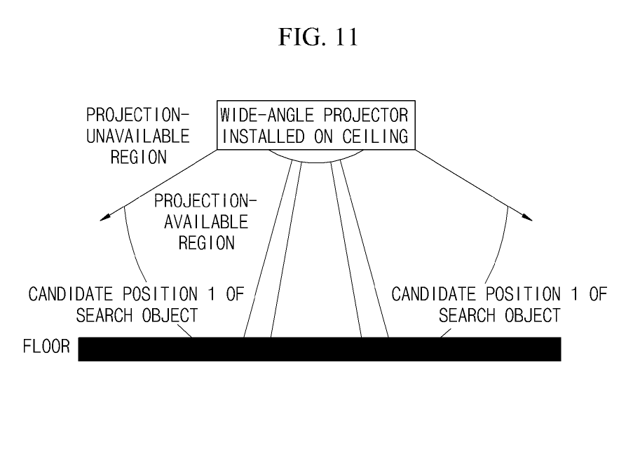

Hereinafter, examples of a method for controlling virtual resources utilizing situation information and a method of tracking an object location in a space will be described with reference to FIGS. 7 through 12.

<Example of Method of Controlling Virtual Resources with Gesture Utilizing Situation Information>

As illustrated in FIG. 7, it is assumed that a TV, an electric light, a refrigerator, a space monitoring resource, and the like registered as virtual resources exist in a space. The devices may be respectively controlled by using a user's gesture. For example, when the user points out an electric light at an upper end of the right side, information of an electric light virtual resource may be displayed on the TV. A name of the resource may appear on the TV and a current operational state and an operating method may be displayed on the TV. In detail, a phrase, an icon, an animation, or the like, such as “Please raise your hand to turn on light” may be output, and the user may control a device with reference to the information.

In detail, the situation information processing unit 17 tracks and observes a user behavior by using space monitoring resources (e.g., a video camera, or the like) registered as a virtual resource. When the situation information processing unit 17 determines that a specific virtual resource is selected (for example, in a case in which a predefined gestures is recognized), the virtual resource controller 12 generates a command and delivers the same to a corresponding virtual resource through the assist gateway 20 such that the virtual resource having a screen display device outputs state and control information regarding the corresponding virtual resource.

In this case, several virtual resources having a screen display device may exist in the space, and in this case, relevant information may be output to a virtual resource closest to a user's eye direction. Distributing virtual resources providing a service and configuring a service in a specific virtual resource are performed by the foregoing collaborative service configuring unit.

<Example of Method for Tracking Location of Object Utilizing Situation Information>

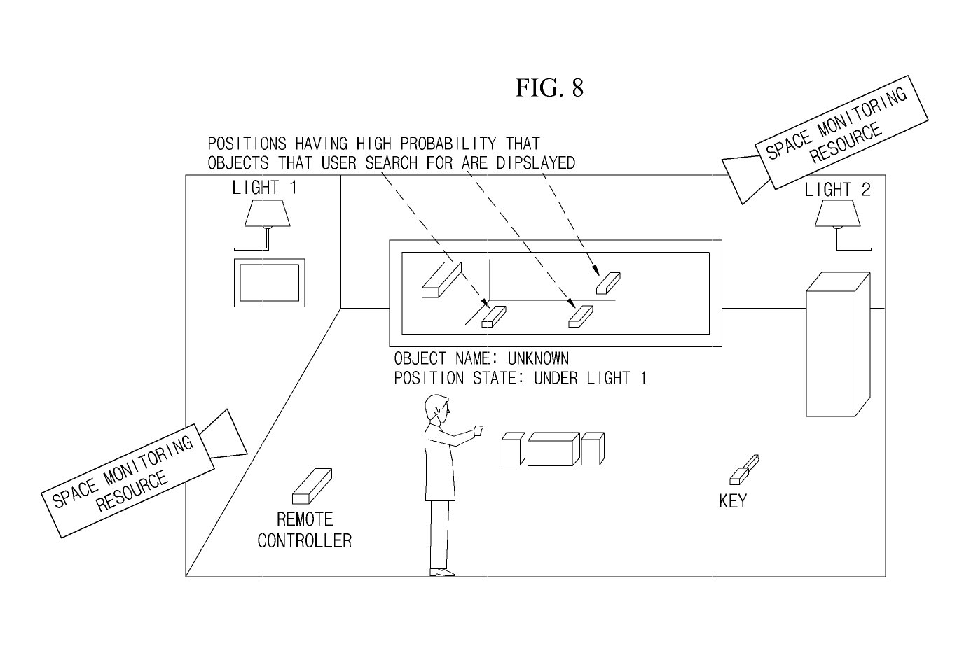

Various objects may exist in a space such as a house or an office, and here, a user may forget where he or she has put objects in many cases. For example, it is assumed that a user has put a remote controller or a key somewhere but he or she cannot remember it. FIGS. 8 through 12 illustrate an embodiment of searching for an object based on collaborative virtual resources.

For example, when a user speaks “remote controller location” to search for a remote controller, information regarding spots having high probability of presence of the remote controller may be displayed on a TV near the user (please refer to FIG. 8).

In detail, a microphone obtaining sound information may be installed in a space monitoring resource (for example, a video camera, or the like). A voice command “remote controller location” is input to the space monitoring resource and delivered to the situation information processing unit 17 through the assist gateway 20. When an object recognized as a remote controller is included in the objects tracked by the situation information processing unit 17, location information of the remote controller is displayed on the TV, or otherwise, location information regarding unknown objects under tracking in location is displayed on the TV.

Location information of an object to be searched may be expressed intuitively by using the collaborative virtual resource controlling. Namely, spots having high probability of presence of an object searched by a user are displayed by using a search light or a wide-angle project adjustable in direction.

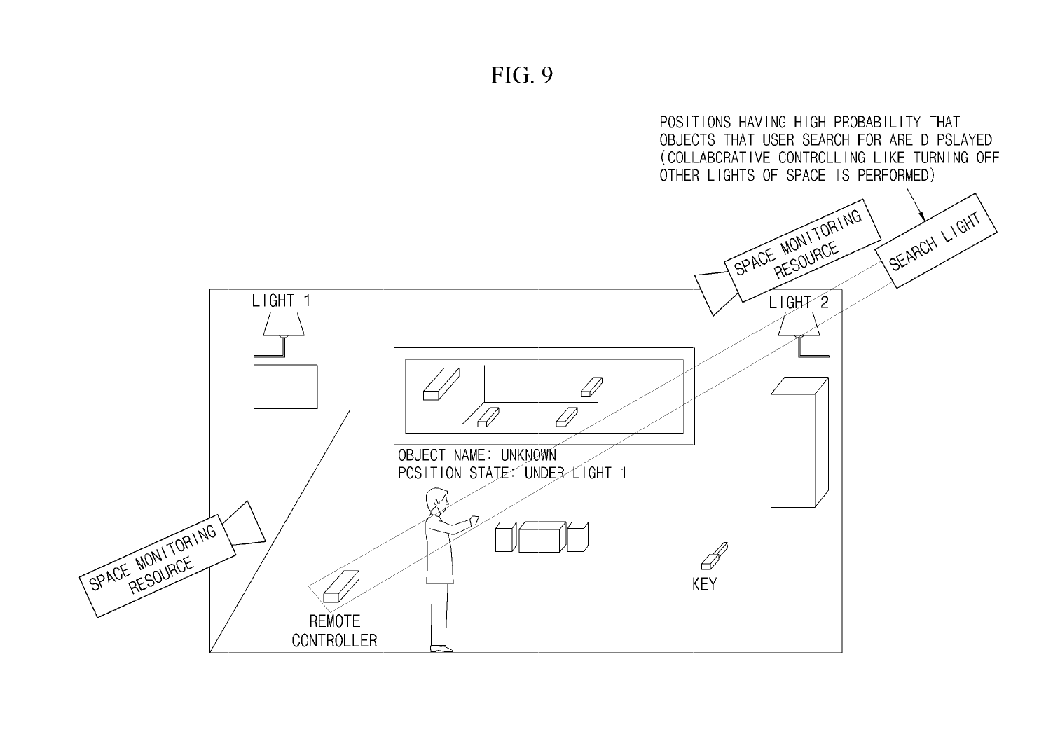

An example of a method of displaying a location of an object to be searched by using a search light is illustrated in FIG. 9.

If an object supposed to be a remote controller is in a lower end at the right side in FIG. 9, a search light may illuminate the corresponding location to display a location. When a current state is night and an electric light is turned on in a space to brighten the space, neighboring lightings may be turned off and only the search light may be provided to more emphatically highlight the location to be searched. In this case, the remote controller may be at several locations, and in this case, a method of more emphatically highlighting a location having high probability of presence of the remote controller may also be used. In this manner, in order to turn off other devices and turn on only the search light, the inter-device collaborative operation as described above needs to be performed.

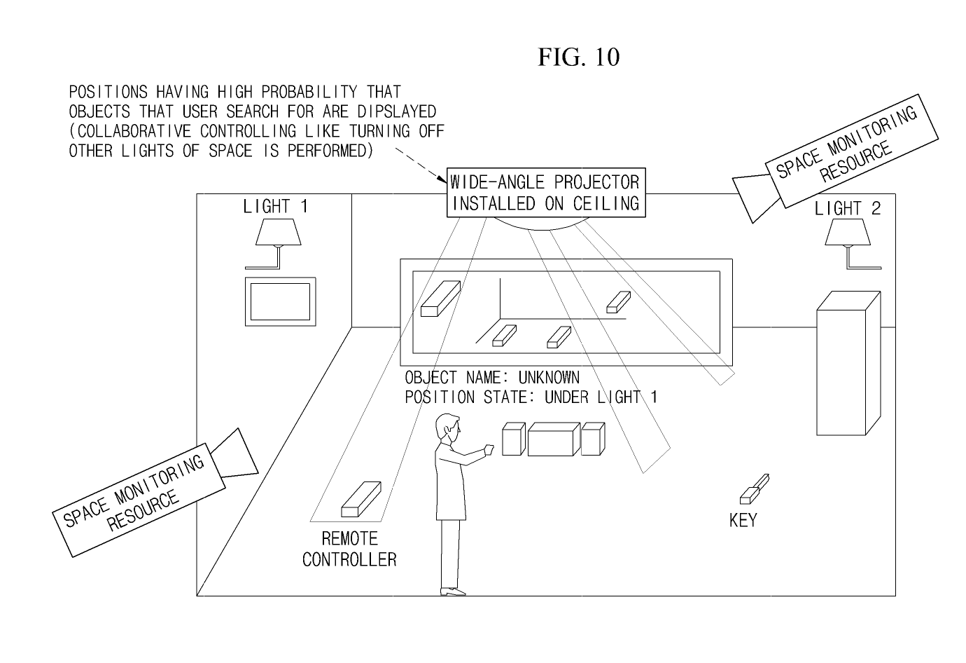

Another example of displaying a location is illustrated in FIG. 10. FIG. 10 illustrates a method of displaying a location by using a wide-angle protector.

For example, candidate locations of searched objects may be displayed at a time by using a wide-angle projector having wide-angle projection. As illustrated in FIG. 10, candidate locations of searched objects may be displayed by using a wide-angle projector installed on the ceiling.

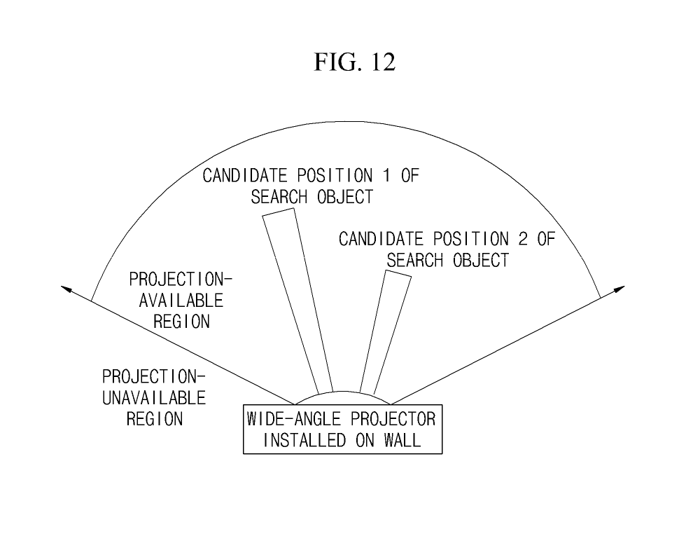

On the other hand, as illustrated in FIG. 12, a wide-angle projector may be installed on the wall to display candidate locations of searched objects.

In order to display candidate locations of searched objects by using a search light or a wide-angle projector, physical locations with respect to searched objects recognized by a camera and physical locations to be displayed by the wide-angle projector need to be identical. Thus, the embodiment of the present invention may include a calibration process.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing a collaborative service based on virtual resources, the method comprising:
generating virtual resources virtualized according to unique services or characteristics of devices connected through an assist gateway in a specific space and collecting virtual resource information including internal states of the virtual resources and services provided by the virtual resources;
configuring a collaborative service with respect to the virtual resources using the virtual resource information; and
generating a control command with respect to at least one or more virtual resources defined in a requested collaborative service.

2. The method of claim 1, wherein the configuring of a collaborative service comprises receiving a collaborative service generated by an external mashup service server from the external mashup service server through an application programming interface (API) allowing for controlling the virtual resources.

3. The method of claim 1, further comprising:
generating a user interface with respect to state information monitored based on the virtual resource information and a control method;
providing the generated user interface to an external client; and
receiving, by the client, a control command with respect to the virtual resources generated by using the user interface.

4. The method of claim 1, further comprising:
obtaining situation information including at least one of a location, an identity, an activity, and time of a device or a person by using at least one of the virtual resources,
wherein the generating of a control command comprises referring to the situation information.

5. An apparatus for providing a collaborative service based on virtual resources, the apparatus comprising:
a virtual resource generating unit configured to generate virtual resources virtualized according to unique services or characteristics of devices connected through an assist gateway in a specific space and collecting virtual resource information including internal states of the virtual resources and services provided by the virtual resources;
a collaborative service configuring unit configured to configure a collaborative service with respect to the virtual resources using the virtual resource information; and
a virtual resource controller configured to generate a control command with respect to at least one or more virtual resources defined in a requested collaborative service.

6. The apparatus of claim 5, wherein the collaborative service configuring unit receives a collaborative service generated by an external mashup service server from the external mashup service server through an application programming interface (API) allowing for controlling the virtual resources.

7. The apparatus of claim 5, further comprising:
a user interface generating unit configured to generate a user interface with respect to state information monitored based on the virtual resource information and a control method,
wherein the virtual resource controller receives a control command with respect to the virtual resources generated by an external client by using the user interface.

8. The apparatus of claim 5, further comprising:
a situation information processing unit configured to obtain situation information including at least one of a location, an identity, an activity, and time of a device or a person by using at least one of the virtual resources,
wherein the virtual resource controller generates a control command with respect to the virtual resources with reference to the situation information.
